(19) United States
(12) Patent Application Publication
(10) Pub. No.: US 2019/0076908 A1
(43) Pub. Date: Mar. 14, 2019

(54) Method and Apparatus for Forming Materials with Low Ductility

(71) Applicant: Magna International Inc., Aurora (CA)

(72) Inventors: Boris Shulkin, West Bloomfield, MI (US); Maximilian Amtmann, Brampton (CA); Hongping Gu, Newmarket (CA)

(21) Appl. No.: 16/189,760

(22) Filed: Nov. 13, 2018

Related U.S. Application Data
(63) Continuation-in-part of application No. 15/784,552, filed on Oct. 16, 2017.
Application No. 15/784,552 is a continuation of application No. 13/698,314, filed on Nov. 16, 2012, now abandoned.
(60) Provisional application No. 61/345,348, filed on May 17, 2010.

(51) Int. Cl. B21D 39/02; B21B 1/00; B32B 38/00; C22F 1/04; B21B 1/38; C22F 1/06; B21D 37/16

(52) U.S. Cl. CPC B21D 39/02; B21B 1/00; B32B 38/0012; C22F 1/04; Y10T 156/1002; C22F 1/06; B21D 37/16; B21D 39/023; B21B 1/38

(57) ABSTRACT

A method of hemming a low ductile material includes providing a first sheet made from the low ductile material and providing an integrated hemming device having at least one laser head and a roll forming assembly comprising a roller. The first sheet is hemmed by moving the roll forming assembly relative to the first sheet along a hemming direction, wherein the roll forming assembly is arranged relative to the first sheet to form a bending region in front of the roll forming assembly. The at least one laser head directs laser light along two optical paths to form two irradiation spots. One of the irradiation spots irradiates a localized portion of the first sheet along the hemming direction at a substantially constant predetermined distance in front of the roll forming assembly and within the bending region, and the other of the irradiation spots irradiates a portion of the roller.

### FIELD OF THE INVENTION

The present invention relates generally to the field of forming materials of low ductility, and more particularly to a method and an apparatus for forming materials of low ductility.

### BACKGROUND OF THE INVENTION

Many industries aim to reduce the weight of the products they produce while at the same time still maintain a structural integrity of the product. In this context, more lightweight metals and metal alloys, such as aluminum, magnesium and their alloys, have gained increasing interest owing to their relatively low density and their relatively high specific strength in comparison to more traditional metal or metal alloys, such as steel. Nevertheless, these materials have a relatively lower ductility which can lead to the formation of cracks or other defects when these materials are bent or folded.

In materials science, ductility is a solid material's ability to deform under tensile stress. Ductility is especially important in metalworking, as materials that crack or break under stress cannot be manipulated using metal forming processes, such as hammering, bending, rolling, roller hemming, and/or drawing.

Therefore, it is desirable to provide a forming process and apparatus for forming materials of relatively low ductility.

It is also desirable to provide a roller hemming process and apparatus for forming materials with relatively low ductility.

Systems for hemming the edges of two or more metal components together to form a part are well known. Such systems are commonly used in the manufacture of various automotive body parts, such as doors, lift gates, hoods, etc., as well as in the manufacture of a variety of other manufactured goods.

Hemmed joints are well known in the automobile industry and, amongst other things, are used to join together inner and outer metal panels of doors and other closure members of automotive vehicles. Resulting hem joints each generally include a flange of metal of one panel being folded over onto an edge of another panel. Typically, in automotive vehicle construction, a peripheral flange or outer edge region of an outer panel is folded over and onto an outer edge region of an inner panel. The resulting hemmed joint provides a finished edge and a mechanical connection between the two panels that adds strength and rigidity to the member.

When, for example, an automobile door is to be fabricated in a prior art hemming press, a previously stamped outer door panel is loaded onto an appropriately shaped anvil and the previously stamped inner door member is then placed atop the inside of the outer door panel and is held in place, with a clamp or other suitable mechanism, with the edges of the outer door panel and the inner door member overlying each other. The hemming press is then activated, moving an appropriately shaped first hemming beam through a complex motion, over and onto the anvil, to fold the edges of the outer door panel and inner door member over onto each other to a first extent, typically about forty-five degrees.

The first hemming beam is then removed, and a second appropriately shaped hemming beam is moved through another complex motion, over and onto the anvil, to complete the hem by further folding the edges of the outer door panel and inner door member over onto each other to complete the part.

The use of aluminum and/or magnesium and their alloys in the manufacture of automotive bodies and components has increased due to the desire to reduce the weight of the vehicles for improved fuel economy, for example. Aluminum and/or magnesium and their alloys have a relatively low ductility which can lead to the formation of cracks or other defects in the bent or folded structure resulting from the hemming process of an inner and an outer panel.

Roller hemming is a relatively recent development for joining inner and outer body panels by folding the outer flange over the edge of the inner panel. This process can create a sharp hem appearance comparable to conventional hemmers for typical steel sheet panels. However, when hemming metal or metal alloy panels of low ductility, conventional hemmers must be modified to reduce the bending severity of the metal or metal alloy sheets in order to prevent cracking along the hemline. With conventional hemmers, it is very difficult to produce sharp, flat hems.

### SUMMARY OF THE INVENTION

In accordance with an aspect of at least one embodiment, there is provided a method of hemming a low ductile material, comprising: providing a first sheet made from the low ductile material; providing an integrated hemming device comprising: at least one laser head; and a roll forming assembly comprising a roller, wherein the at least one laser head is configured to direct laser light along two optical paths so as to form two irradiation spots that are at least partially non-overlapping one with the other; hemming the first sheet, comprising moving the roll forming assembly relative to the first sheet along a hemming direction, the roll forming assembly being arranged relative to the first sheet to form a bending region in advance of the roll forming assembly, so as to fold an edge portion of the first sheet back upon itself during moving along the hemming direction, thereby hemming the first sheet; using the at least one laser head, directing laser light along one of the two optical paths to irradiate with one of the two irradiation spots a localized portion of the first sheet along the hemming direction at a substantially constant predetermined distance in front of the roll forming assembly and within the bending region; and using the at least one laser head, directing laser light along the other one of the two optical paths to irradiate with the other one of the two irradiation spots a portion of the roller.

In accordance with an aspect of at least one embodiment, there is provided a method of hemming a low ductile material, comprising: providing a first sheet made from the low ductile material; providing an integrated hemming device comprising: at least one laser head; and a roll forming assembly comprising a roller, wherein the at least one laser head is configured to direct laser light along two optical paths so as to form two irradiation spots that are at least partially non-overlapping one with the other; hemming the first sheet, comprising moving the roll forming assembly relative to the first sheet along a hemming direction, the roll forming assembly being arranged relative to the first sheet to form a bending region in advance of the roll forming assembly, so as to fold an edge portion of the first sheet back upon itself during moving along the hemming direction, thereby hemming the first sheet; using the at least one laser head, directing laser light along one of the two optical paths to irradiate with one of the two irradiation spots a first localized portion of the first sheet along the hemming direction at a first substantially constant predetermined distance in front of the roll forming assembly and within the bending region; and using the at least one laser head, directing laser light along the other one of the two optical paths to irradiate with the other one of the two irradiation spots a second localized portion of the first sheet along the hemming direction at a second substantially constant predetermined distance in front of the roll forming assembly, wherein the first localized portion and the second localized portion are at least partially non-overlapping one with the other.

In accordance with an aspect of at least one embodiment, there is provided a hemming apparatus for hemming a panel assembly including an outer panel and an inner panel, the apparatus comprising: a roll forming assembly comprising a roller for hemming the panel assembly; a retaining device for positioning the panel assembly relative to the roll forming assembly; and a laser source; wherein the laser source and the roller assembly are configured to be movable as a unit, and wherein the laser source is configured to, during use, direct laser light along two optical paths so as to form two irradiation spots that are at least partially non-overlapping with one another other.

In accordance with an aspect of at least one embodiment, there is provided a method of forming a material of low ductility comprising the steps of providing a first sheet made from a material of low ductility, providing an integrated forming device comprising a heat source and a forming element, and moving the forming element relative to the first sheet along a forming direction while simultaneously heating a localized portion of the first sheet along the forming direction at a substantially constant predetermined distance in front of the forming element. The predetermined distance is selected so as to yield a predetermined temperature to achieve a predetermined ductility at the localized portion of the first sheet when the forming element reaches the localized portion of the first sheet.

In accordance with an aspect of at least one embodiment, the step of heating comprises irradiating the localized portion of the first sheet with an energy beam. The energy beam can be a laser beam or an infrared beam. Therefore, the heat source can be a laser source or an infrared source. Alternatively, the heat source can also be a source of induction heat.

In accordance with an aspect of at least one embodiment the forming element comprises a roll forming element. The roll forming element can have one or more rollers and the forming step can be performed in one or more roller passes.

In accordance with an aspect of at least one embodiment the forming operation can be a bending, a roller hemming, a hammering, a rolling, and/or a drawing operation.

In accordance with an aspect of at least one embodiment the laser beam has a large spot at the predetermined forming area. The large spot laser beam can be chosen to be a defocused beam or an enlarged beam produced by beam shaping optical components. Alternatively, the large spot laser beam is a raw beam generated directly by a laser source. Furthermore, the laser beam can be selected to be a round beam or a rectangular beam.

In accordance with an aspect of at least one embodiment the low ductile material is made from aluminum, aluminum alloy, magnesium, and/or magnesium alloy.

In accordance with an aspect of at least one embodiment the step of heating is performed at a temperature in a range between about 150° C. to about 500° C.

In accordance with an aspect of at least one embodiment the step of heating comprises the step of varying the incident angle of the laser beam on the localized portion of the first sheet.

In accordance with an aspect of at least one embodiment the method further includes the step of providing a programmable logic control for retrieving a predetermined forming temperature for the material of low ductility and an incident angle of the laser beam on the localized portion of the first sheet.

In accordance with an aspect of at least one embodiment a method is provided comprising the further steps of providing a second sheet adjacent to the first sheet, securing the first sheet relative to the second sheet, said first sheet having a peripheral flange and said second sheet having a peripheral edge, moving the forming element relative to the first and second sheet to fold the peripheral flange of the first sheet over the peripheral edge of the second sheet along a forming direction along the peripheral flange while simultaneously heating a localized portion of the peripheral flange along the forming direction at a substantially constant predetermined distance in front of the forming element. The predetermined distance is selected so as to yield a predetermined temperature to achieve a predetermined ductility at the localized portion of the first sheet when the forming element reaches the localized portion of the first sheet.

In accordance with an aspect of at least one embodiment the invention provides an apparatus for forming a material of low ductility comprising an integrated forming device including a forming element and an energy source, wherein the forming element and the energy source advance simultaneously relative to the material of low ductility. The forming device can comprises a roller forming element. The energy source can be a laser source, an infrared source, or a source of inductive heat.

In accordance with an aspect of at least one embodiment there is provided a method of roller hemming a panel assembly including an outer panel and an inner panel comprising the steps of providing the outer panel having a peripheral flange, providing the inner panel adjacent the outer panel, the inner panel having a peripheral edge, securing the outer panel relative to the inner panel, and moving a roller element relative to the outer and the inner panel to fold the peripheral flange of the outer panel over the peripheral edge of the inner panel along a forming direction along the peripheral flange while simultaneously heating a localized portion of the peripheral flange along the forming direction at a substantially constant predetermined distance in front of the roller element. The predetermined distance is selected so as to yield a predetermined temperature to achieve a predetermined ductility at the localized portion of the peripheral flange when the roller element reaches the localized portion of the peripheral flange. The step of heating comprises the step of irradiating the localized portion with an energy beam. The energy beam can be a laser beam or an infrared beam. In accordance with an embodiment of the invention, the roller element comprises at least one roller. Alternatively, two or more rollers can be employed. If desired, the hemming operation can be performed in one or more passes.

In accordance with an aspect of at least one embodiment a laser beam aiming angle can be varied with a folding angle of the roller element so that an incident spot of the laser beam on the surface of the peripheral flange is optimized.

In accordance with an aspect of at least one embodiment the method comprises the further step of determining a forming temperature at the localized portion in dependence upon the material prior to the forming step. The method can comprise the further step of determining a number of forming steps in dependence upon a degree of bending.

In accordance with an aspect of at least one embodiment the method includes the further step of pre-hemming the peripheral flange of the outer panel.

In accordance with an aspect of at least one embodiment there is provided a roller hemming apparatus for hemming a panel assembly including an outer panel and an inner panel, the apparatus comprising a roller element for forming the panel assembly, a retaining device for positioning the panel assembly relative to the roller element; and a heat source moving in unison with the roller element, wherein the heat source is for emitting an energy beam onto a localized portion of the panel assembly at a substantially constant predetermined distance in front of the roller element. The predetermined distance is selected so as to yield a predetermined temperature to achieve a predetermined ductility at the localized portion of the panel assembly when the roller element reaches the localized portion of the panel assembly.

### BRIEF DESCRIPTION OF THE DRAWINGS

Exemplary embodiments of the invention will now be described in conjunction with the following drawings wherein like numerals represent like elements, and wherein:

FIGS. 1a and 1b show a flat sheet before and after undergoing a forming process in accordance with the instant invention;

FIGS. 2-6 are schematic presentations illustrating a hemming process in accordance with an embodiment of the invention;

FIG. 7 shows a photographic image of a hemmed panel assembly made by conventional roller hemming;

FIGS. 8 and 9 show a partial roller hemming apparatus in accordance with the instant invention combining a laser head with a roller hemming device;

FIGS. 10-12 show the panel assembly in the roller hemming apparatus of the instant invention and how the laser beam is applied simultaneously in front of the hemming rollers; and

FIG. 13 shows a photographic image of a hem line produced in accordance with the instant invention.

FIG. 14 shows a partial roller hemming apparatus in accordance with an embodiment of the invention combining a laser head with a roller hemming device, the laser head projecting a plurality of laser beams;

FIG. 15 shows a partial roller hemming apparatus in accordance with an embodiment of the invention combining a plurality of laser heads with a roller hemming device;

FIG. 16 illustrates a hemming process in accordance with an embodiment of the invention;

FIG. 17 illustrates another hemming process in accordance with an embodiment of the invention;

FIG. 18 illustrates another hemming process in accordance with an embodiment of the invention, in which a divergence laser beam is used.

### DETAILED DESCRIPTION OF THE PREFERRED EMBODIMENTS

The following description is presented to enable a person skilled in the art to make and use the invention and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed but is to be accorded the widest scope consistent with the principles and features disclosed herein.

In accordance with at least one embodiment, a process and an apparatus for forming materials with a relatively low ductility are provided. In accordance with another aspect of the invention, a roller hemming process and apparatus are provided for hemming materials with a relatively low ductility. The process and apparatus are particularly advantageous for roller hemming inner and outer panels comprised of metal or metal alloys having a low ductility. Examples of such metal or metal alloys are magnesium and aluminum and their alloys.

In the context of this application, the term “low ductile material” refers to any material having a ductility such that a forming operation would introduce cracks or other defects in the formed material.

In the context of this application, the term “laser head” refers to the assembly from which the laser beam exits toward the work piece. The laser head may not contain the laser source. The laser head comprises at least focusing optics, and may comprise a protection glass and/or additional facilities e.g. to direct a gas flow to the irradiated zone. The laser light may enter the laser head via a high power optical fiber cable.

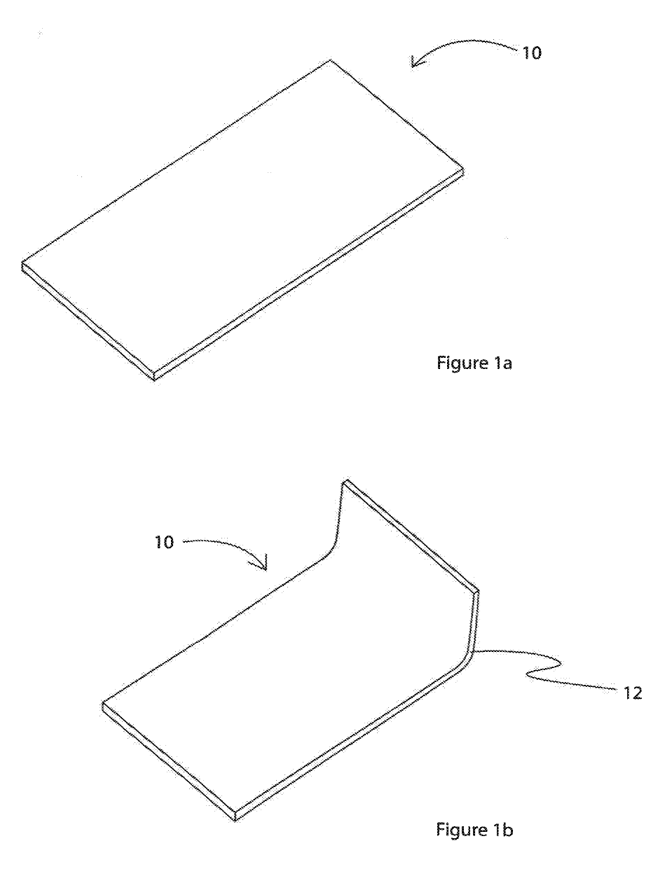

Having regard to FIGS. 1a and 1b, a flat sheet 10 is shown before undergoing a forming process (FIG. 1a) and after undergoing a forming process in accordance with the instant invention (FIG. 1b) along an edge 12. In accordance with the instant invention, sheet 10 is made from a relatively low ductile material, such as aluminum, magnesium and their alloys, and the bend along edge 12 is formed in accordance with a process and apparatus of the instant invention. Exemplary forming processes include hammering, bending, rolling, roller hemming, and/or drawing.

In accordance with the instant invention, a method and an apparatus for forming materials with relatively low ductility are provided. An integrated forming device is provided which combines a heat source, such as a laser source, an infrared source, or a source of induction heat, with a forming device. The heat source heats the metal or metal alloy to a predetermined temperature in dependence upon the low ductile material to be formed at a predetermined location where the material is to be formed, so as to increase the ductility of the metal or metal alloy at the predetermined location. The forming device simultaneously performs the forming operation at the predetermined location as the heat source applies heat to the predetermined location. The heat source emits an energy beam which advances the forming device as the integrated forming device advances along the predetermined location where the material is to be formed. The metal or metal alloy of the sheet to be formed is heated to an optimum temperature to achieve a predetermined ductility that allows the sheet to be formed without showing surface cracks or any other defects in the formed sheet. Therefore, the process and apparatus in accordance with the present invention provide heat to a localized area of the sheet to be formed and hence allow the material to be formed at a desired optimum temperature and allow to introduce minimum heat input to avoid unnecessary heat distortion in the formed sheet. Moreover, the process and apparatus in accordance with the instant invention also allow for a reduction in cycle time.

In accordance with another aspect of the invention, the process and apparatus of the instant invention are particularly advantageous for roller hemming applications where an extreme bend is formed in the low ductile material.

Thus, in accordance with an aspect of the present invention, a roller hemming apparatus is provided with an energy source, such as a laser source. Examples of laser sources that can be used in accordance with the instant invention are carbon dioxide lasers, Nd:YAG lasers, and laser diodes. The laser head emits a laser beam which advances the hemming rollers. The laser beam heats the metal or metal alloy about the predetermined hemline so as to increase the ductility of the metal or metal alloy. The hemming rollers follow the laser beam so that the heating and the hemming operation are performed simultaneously on the metal or metal alloy while it is still warm, i.e. a warm-forming process. The metal or metal alloy of the panels to be hemmed is heated to an optimum temperature to achieve a predetermined ductility that allows a hem to be formed without showing surface cracks or any other defects. The use of a laser is advantageous as it provides a short and localized heating about the predetermined hemming location or hemline. Therefore, a laser-assisted hemming process in accordance with the present invention provides heat to a localized area of the metal or metal alloy panels and hence allows to minimize a heat input, reduces distortion of the panels to be hemmed, and can be performed in a relatively short period of time. On the contrary, some prior art methods disclose a pre-annealing process to increase the ductility of some panels so as to achieve a clean hemline, which would significantly increase the cycle time. In accordance with the instant invention, the cycle time for hemming materials with low ductility can be reduced by simultaneously heating and hemming at the predetermined hemming location or hem line.

In accordance with a further aspect of the invention, the laser beam has a large spot at the irradiated location which is covering the entire bending radius or curvature area so as to allow more material to be involved in the stretch. Examples of enlarged laser beams are a defocused beam or an enlarged beam produced by beam shaping optics. Alternatively, a raw beam of proper size directly from the laser can be used. In accordance with a further embodiment of the invention, the geometry of the laser beam can be selected in accordance with a particular application. For example, the laser beam can be a round beam or a rectangular beam.

In accordance with an aspect of the invention, a defocused laser beam is used to provide a relatively small amount of power. The panels to be hemmed are typically heated to a temperature between about 150-500° C. for panels made from aluminum, magnesium, and/or their alloys. Nevertheless, the particular temperature depends on the material of which the panels are comprised so as to locally increase the ductility of the panel about a predetermined bending region or hem line.

In accordance with yet another aspect of the invention, the type of low ductile material determines the optimum temperature to which the metal or metal alloy is heated as well as an incident angle of the laser beam.

In accordance with a further aspect of the invention, a programmable logic control (PLC) can be used to retrieve an optimum forming temperature and incident angle of the laser beam.

In accordance with yet another aspect of the invention, the forming operation can be carried out in a single roller forming step or in two or more roller forming steps while simultaneously applying an energy beam to the forming location.

In accordance with another aspect of the invention, the forming temperature and the number of forming steps are selected in dependence upon a degree of bending or in other words, in dependence upon a complexity of a forming shape of the formed product. For example, a 5K Aluminum alloy can be formed in a single rolling step if the forming temperature generated by the laser beam during forming is between about 250° C.-260° C., or in two rolling steps if the forming temperature generated by the laser beam during forming is between 180° C.-220° C.

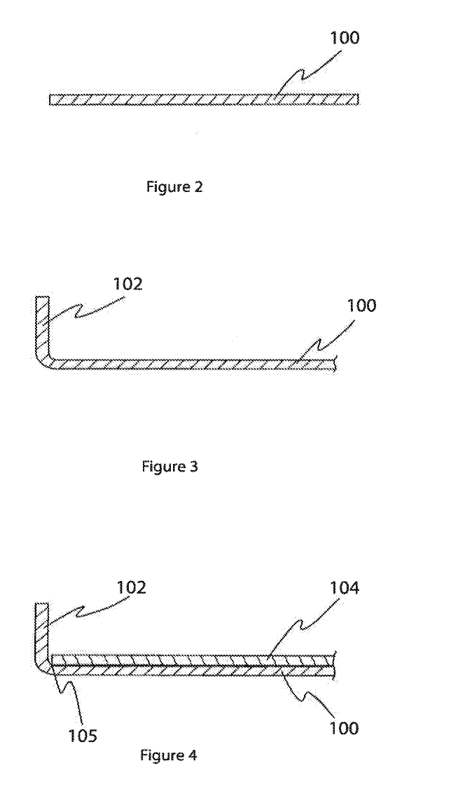

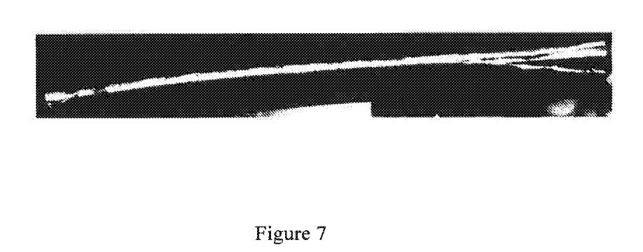

Turning now to FIGS. 2-6, an outer panel 100 and an inner panel 104 are provided. The outer and inner panels may be prepared by various metal forming processes, such as roll forming, drawing or stamping and cutting. For example, motor vehicle body panels, doors, hoods, fenders, tailgates, trunks and deck lids can be constructed by stamping an outer sheet metal panel and separately stamping an inner sheet metal reinforcing panel and then joining the two panels together by hemming a flange of the periphery of the outer panel over an adjacent edge of the inner panel to secure the panels together. Advantageously, the outer panel is slightly larger than the inner panel to provide a border flange portion along the periphery of the outer panel that can be folded over the peripheral edge of the inner panel to define the hem flange that connects the two panels. Outer panel 100 and inner panel 104 may be composed of various types of steel, aluminum, aluminum alloys, magnesium, and/or magnesium alloys. However, aluminum, magnesium and their alloys have a relatively low ductility at room temperature and if hemmed at this temperature usually show some surface defects about the hem line, such as cracks, when processed at this temperature. FIG. 7, for example, shows a photographic image of a panel assembly made by conventional roller hemming, and wherein the outer panel of the panel assembly is made from a low ductile material. The panel assembly was hemmed at room temperature and it can be seen from the photographic image that the hemmed assembly has a crack about the hem line.

In accordance with an embodiment of the present invention, outer panel 100 is pre-hemmed about a flange 102 along a periphery of the outer panel 100. FIG. 2 shows the flange to be pre-hemmed at about 90 degrees. Alternatively, the pre-hemming can be performed at various different angles. In accordance with another embodiment of the invention as discussed heretofore, the hemming operation can be done in a single rolling step in which case the pre-hemming step is omitted.

FIG. 4 shows an inner panel 104 positioned adjacent flange 102 of outer panel 100. Both panels are assembled and the panel assembly is fastened with a suitable retainer, such as a clamping device (not shown) for holding the panel assembly in position during the hemming operation. Alternatively, the inner and outer panels can be secured by means of an adhesive.

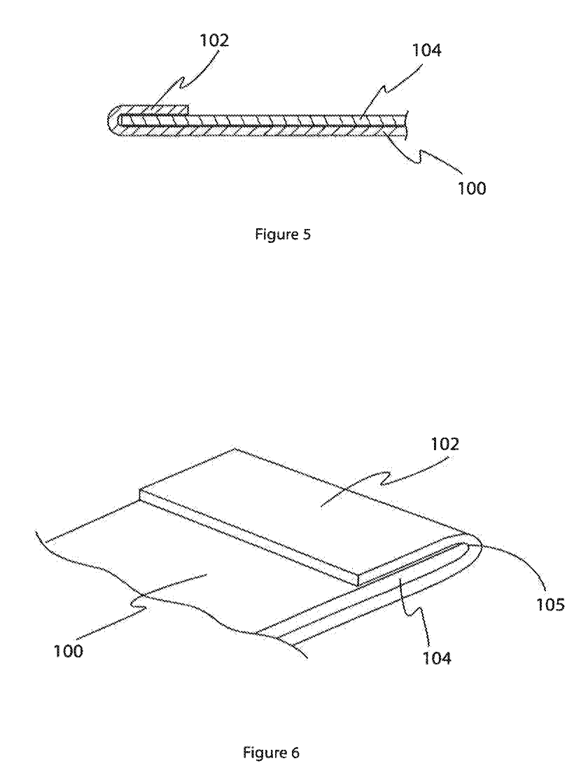

FIG. 5 shows a schematic cross-sectional view of the hemmed panel assembly wherein the flange 102 of outer panel 100 is bend from the 90 degree pre-hemming angle to a 180 degree hemmed angle, i.e. the flange 102 is folded over the peripheral edge 105 of the inner panel 104 to define the hem flange that joins the two panels. FIG. 6 shows an isometric view of the hemmed panel assembly.

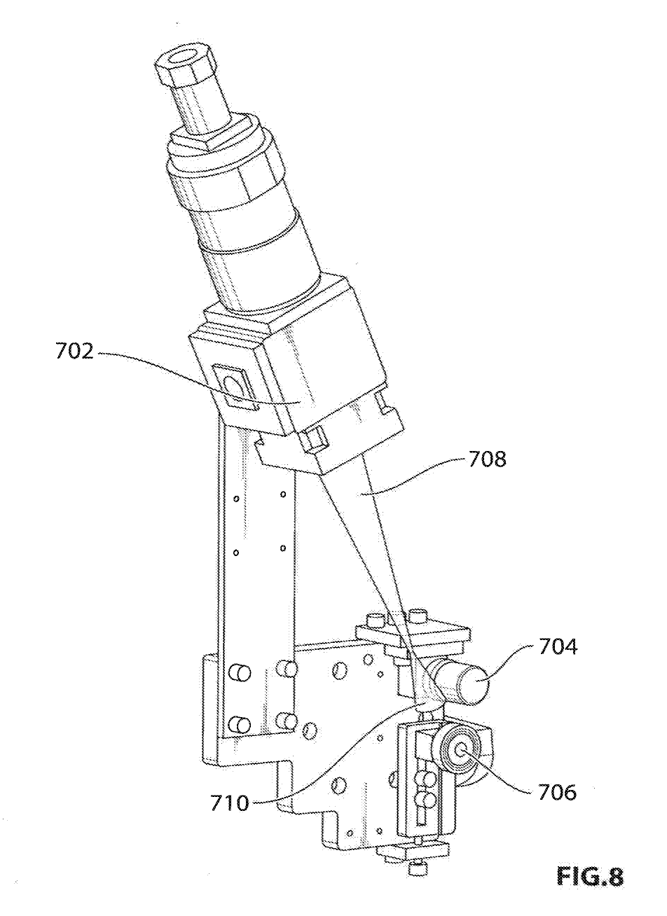

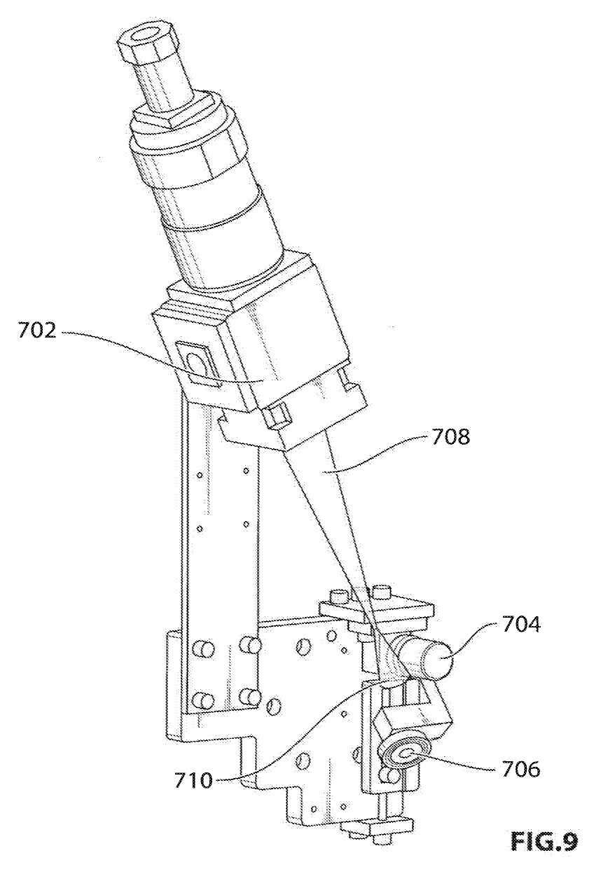

FIGS. 8 and 9 show a partial apparatus in accordance with the instant invention illustrating two configurations for forming employing two different folding angles. A laser head 702 is combined with a roller hemming apparatus as indicated by hemming rollers 704 and 706. A panel assembly (not shown) comprised of an outer panel and an inner panel is held in a retaining device (not shown) and is provided between the hemming rollers 704 and 706. Laser head 702 emits a laser beam 708 which is a defocused beam 710 projected onto the panel assembly provided between the hemming rollers 704 and 706. The laser beam is projected onto the panel assembly and advances the hemming rollers. The laser beam is used to apply the heat directly to a bending region to improve the elongation thereof while the roller hemming apparatus and the remaining part of the panel assembly remain at room temperature. The heat is introduced into the bending region in real time, simultaneously with the roller hemming. The laser beam is applied immediately in front of the hemming rollers. Therefore, the localized heated bending region moves dynamically with the roller hemming apparatus of the instant invention. Furthermore, the laser beam aiming angle can be varied with the folding angle of the roller so that the incident spot of the laser beam on the surface of the flange is optimized.

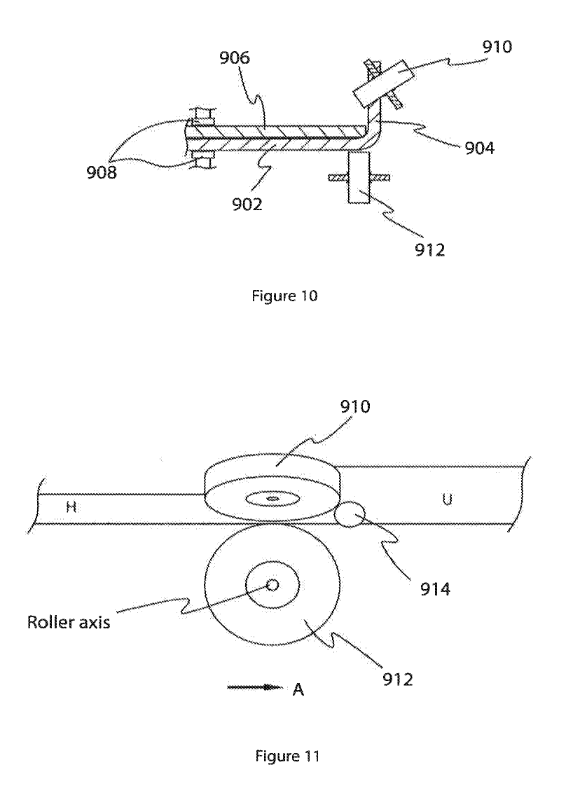

FIG. 10 shows a schematic cross-sectional side view of a panel assembly comprising an outer panel 902 having a pre-hemmed flange 904 and an inner panel 906 positioned in a retaining device 908 between hemming rollers 910 and 912. FIG. 11 shows a schematic top view of a partially hemmed panel assembly. Arrow A indicates the direction in which the hemming rollers 910, 912 advance during the roller hemming process. As can be seen from FIG. 11, the hemming rollers 910, 912 are advanced by a laser beam 914 which simultaneously applies heat directly to a bending region as the roller hemming apparatus moves over the panel assembly to fold the flange of the outer panel over a peripheral edge of the inner panel. In accordance with an embodiment of the instant invention, the inventive roller hemming apparatus combines a laser head with a roller hemming apparatus wherein the laser head and the hemming rollers move as a pair and wherein the laser beam advances the hemming rollers. Region H in FIG. 11 shows a hemmed region of the panel assembly after the roller hemming apparatus in accordance with the instant invention has moved across it and approaching unhemmed region U.

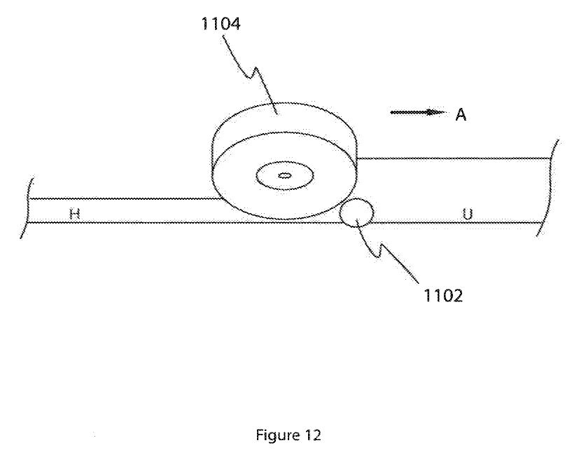

FIG. 12 shows another embodiment of the present invention wherein a single roller is used in the inventive roller hemming apparatus. Laser beam 1102 is applied to a bending region before roller 1104 moves across the bending region. The direction of the roller movement is indicated by arrow A in FIG. 12 and advances from a hemmed region “H” to an unhemmed region “U”.

Alternatively, as was discussed heretofore, instead of a laser head other energy beam sources, such as an infrared source or inductive heat source, can be employed in accordance with the invention. Nevertheless, the use of a laser is advantageous since it can be easily adjusted to any application, i.e. the beam size and shape, incident angle, and intensity of the laser beam can be easily adjusted to any material to be formed. Moreover, the use of beam shaping optical components can provide a predetermined laser beam such that the incident energy beam effects the ductility of the material to be formed in a predetermined manner to yield a formed product without any cracks or other defects.

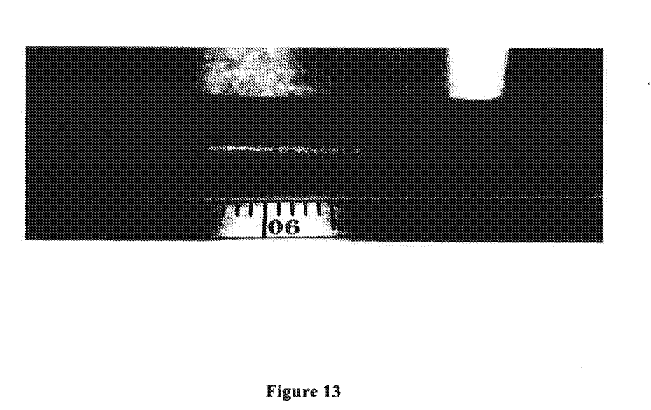

FIG. 13 shows a photographic image of a hemmed panel in accordance with an embodiment of the instant invention. As can be seen from this image, the formed panel assembly is free from cracks and other defects.

Furthermore, in accordance with another aspect of the instant invention, the roller hemming apparatus can be used to achieve three-dimensional flat hemming, i.e. non-straight hem lines can be produced with the roller hemming apparatus of the instant invention, such as for example a round hem line moving around the corner of a motor vehicle hood.

Advantageously, the process and apparatus of the instant invention, employ an energy beam, such as a laser beam, to apply heat directly to a bending region to improve the elongation thereof. The heat is introduced into the bending region in real time, i.e. simultaneously with the forming step, such as roller hemming. The energy beam is applied directly in front of the forming device. The energy beam aiming angle can be varied with the folding angle of the roller so that the incident spot of the energy beam on the surface of the flange is optimized.

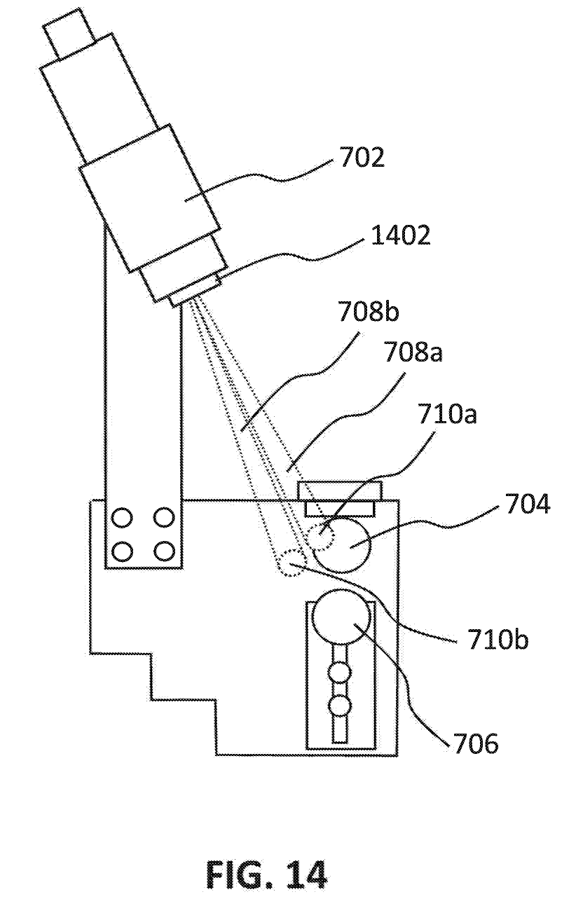

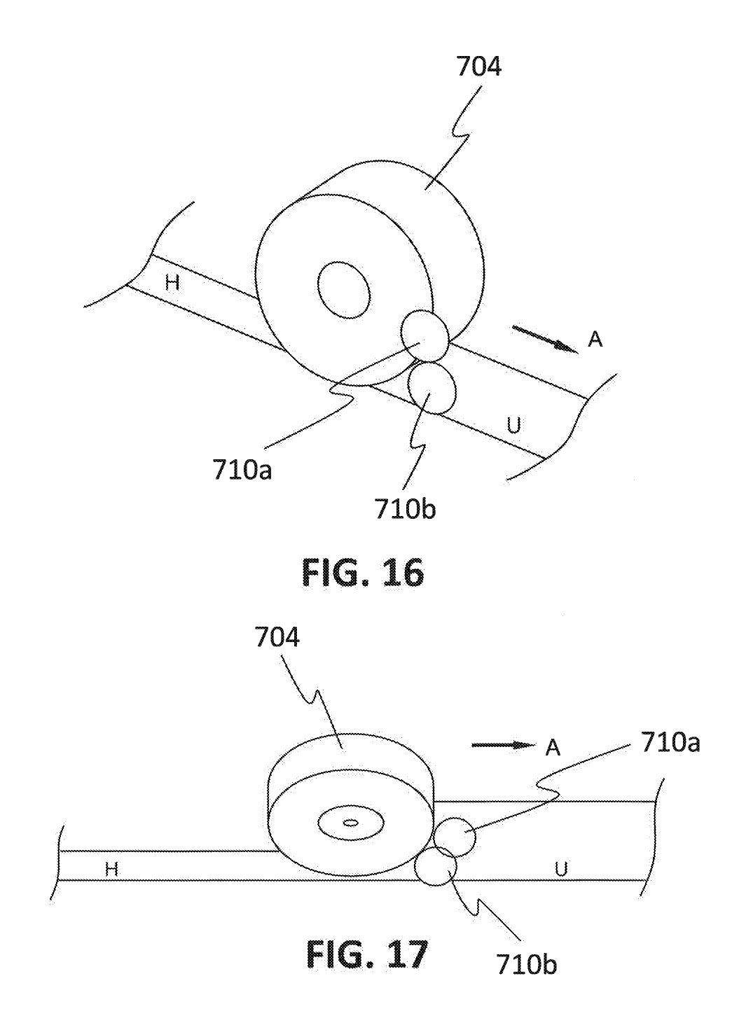

Referring now to FIG. 14, shown is a partial apparatus in accordance with another embodiment of the invention. In accordance with this embodiment a plurality of heating spots is produced on the panel assembly and/or roller in order to improve the quality of the hem that is formed. A laser head 702 is combined with a roller hemming apparatus as indicated by hemming rollers 704 and 706. A panel assembly (not shown) comprised of an outer panel and an inner panel is held in a retaining device (not shown) and is fed between the hemming rollers 704 and 706. In at least some implementations, the hemming roller 706 is merely optional. Laser head 702 emits a laser beam, which is split i.e. using laser optics 1402 to form a plurality of individual laser beams. In the specific example that is shown in FIG. 14, one of the beams 708a is directed toward hemming roller 704 and forms the irradiation spot 710a thereon. The other beam 708b is directed toward the not illustrated panel assembly and forms the irradiation spot 710b thereon. As is shown in more detail in FIG. 16 the laser beam 708b forms spot 710b on an unhemmed region “U” of the panel assembly in front of the hemming rollers, along a hemming direction “A”, so as to apply heat directly into a bending region whilst the laser beam 708a forms spot 710a and applies heat directly to the hemming roller 704. In this implementation, heat is supplied into the panel assembly bending region and into the hemming roller 704 simultaneously with the roller hemming. By heating the hemming roller 704 it is possible to apply less heat directly into the bending region at spot 710a. In addition, the heated roller 704 extends the length of time that the material of the panel assembly remains at a desired elevated temperature, which otherwise tends to cool down quickly after being irradiated by the laser, especially when the panel assembly is squeezed between unheated rollers. Optionally, the laser beam aiming angle can be varied with the folding angle of the roller so that the incident spot of the laser beam on the surface of the flange is optimized.

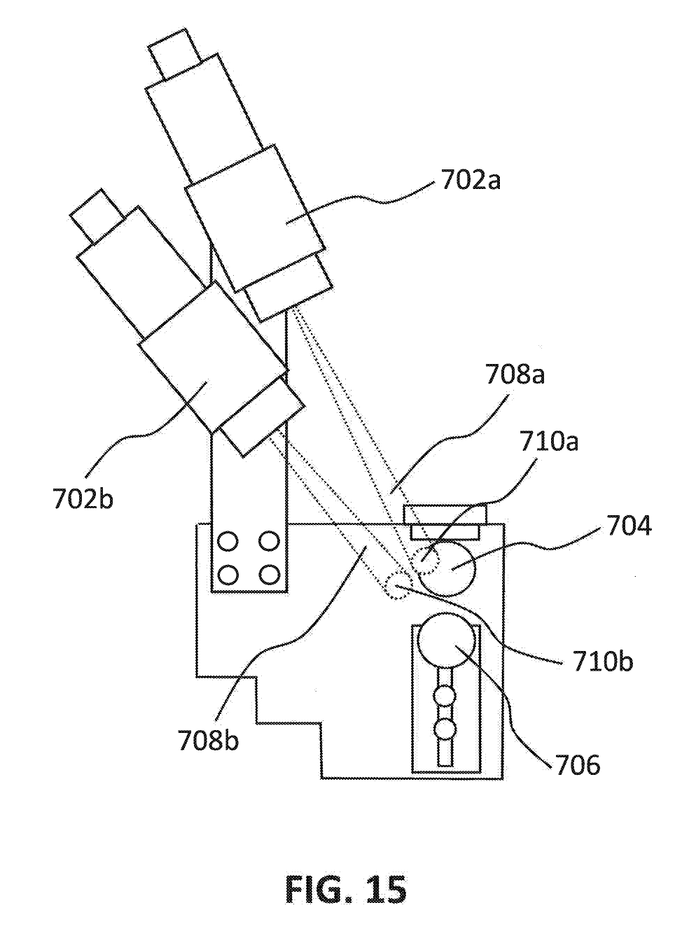

Referring now to FIG. 15, shown is a partial apparatus in accordance with another embodiment of the instant invention. A plurality of laser heads 702a and 702b is combined with a roller hemming apparatus as indicated by hemming rollers 704 and 706. In at least some implementations, the hemming roller 706 is merely optional. A panel assembly (not shown) comprised of an outer panel and an inner panel is held in a retaining device (not shown) and is fed between the hemming rollers 704 and 706. In the configuration that is shown in FIG. 15, laser head 702a produces a first laser beam 708a and laser head 702b produces a second laser beam 708b. One of the beams 708a is directed toward hemming roller 704 and forms an irradiation spot 710a thereon and the other beam 708b is directed toward the not illustrated panel assembly and forms an irradiation spot 710b thereon. As is shown in more detail in FIG. 16 the laser beam 708b forms spot 710b on an unhemmed region “U” of the panel assembly in front of the hemming rollers, along a hemming direction “A”, so as to apply heat directly into a bending region whilst the laser beam 708a forms spot 710a and applies heat directly to the hemming roller 704. In this implementation, heat is supplied into the panel assembly bending region and into the hemming roller 704 simultaneously with the roller hemming. By heating the hemming roller 704, it is possible to apply less heat directly into the bending region at spot 710a. In addition, the heated roller 704 extends the length of time that the material of the panel assembly remains at high temperature, which otherwise tends to cool down quickly after being irradiated by the laser, especially when the panel assembly is squeezed between unheated rollers. Optionally, the laser beam aiming angle can be varied with the folding angle of the roller so that the incident spot of the laser beam on the surface of the flange is optimized.

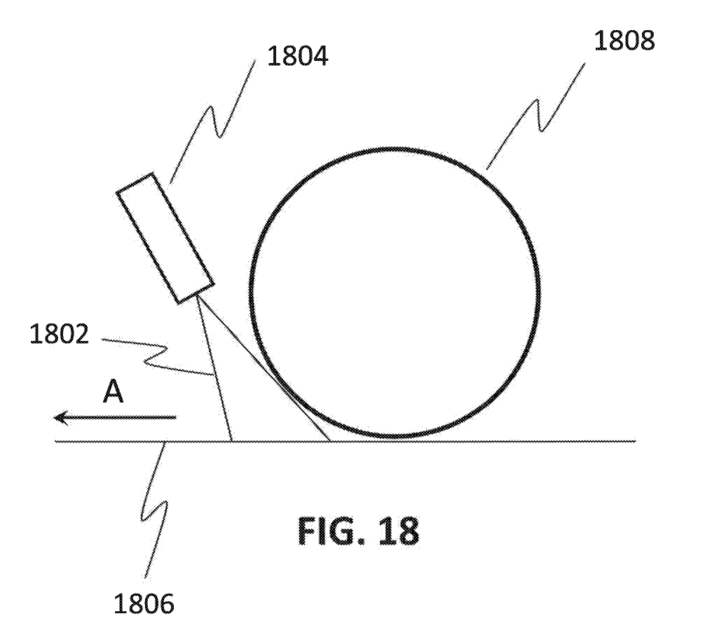

In an alternative implementation shown in FIG. 17, both of the laser beams 708a and 708b, either from a single laser source or from a plurality of separate laser sources, are directed toward the panel assembly, forming a plurality of laser beam spots 710a and 710b thereon. The size and/or the shape and/or the energy density and/or the number of the laser beam spots may be tailored so as to tailor the heating of a desired width of the panel assembly in front of the hemming rollers 704 and 706 in a hemming direction “A.” Optionally the laser beam spots 710a and 710b at least partially overlap with one another and/or the laser beams 708a and 708b have different powers etc., so as to control the heating and therefore the temperature distribution within the bending region of the panel. In this way, it is possible e.g. to heat different portions of the sheet to different depths. Further optionally another source of heat, such as for instance an inductive heating element, is used to heat the hemming roller 704. The heated roller 704 prevents the panel assembly from cooling at a critical time during hemming.

FIG. 18 is a simplified side view of another embodiment showing a divergent laser beam 1802 being delivered from the end of laser fiber 1804 and impinging on a panel assembly 1806. The divergent laser beam 1802 is less focused than the laser beams 708, 708a, 708b in the embodiments that are described above. The divergent laser beam irradiates and heats a relatively larger area of the panel assembly 1806 in front of the roller 1808 in a hemming direction “A.” Further, the divergent laser beam can extend very close to the point where the roller 1808 contacts the panel assembly 1806 without a large incident angle, which allows the roller hemming device to be made more compact. Advantageously, the end of a laser fiber 1804 can be brought right up to the area to be heated since no laser focusing optics are required, which makes this configuration more cost-effective.

It should be appreciated that the foregoing description is illustrative in nature and that the present invention includes modifications, changes, and equivalents thereof, without departure from the scope of the invention.

What is claimed is:

1. A method of hemming a low ductile material, comprising:
providing a first sheet made from the low ductile material;
providing an integrated hemming device comprising:
at least one laser head; and
a roll forming assembly comprising a roller,
wherein the at least one laser head is configured to direct laser light along two optical paths so as to form two irradiation spots that are at least partially non-overlapping one with the other;
hemming the first sheet, comprising moving the roll forming assembly relative to the first sheet along a hemming direction, the roll forming assembly being arranged relative to the first sheet to form a bending region in advance of the roll forming assembly, so as to fold an edge portion of the first sheet back upon itself during moving along the hemming direction;
using the at least one laser head, directing laser light along one of the two optical paths to irradiate with one of the two irradiation spots a localized portion of the first sheet along the hemming direction at a substantially constant predetermined distance in front of the roll forming assembly and within the bending region; and
using the at least one laser head, directing laser light along the other one of the two optical paths to irradiate with the other one of the two irradiation spots a portion of the roller.

2. The method according to claim 1 wherein the at least one laser head comprises a single laser head and comprising using optical elements to direct a first portion of the laser light produced by the single laser head along the one of the two optical paths and to direct a second portion of the laser light produced by the single laser head along the other one of the two optical paths.

3. The method according to claim 1 wherein the at least one laser head comprises a first laser head and a second laser head and comprising using the first laser head to direct the laser light along the one of the two optical paths and using the second laser head to direct the laser light along the other one of the two optical paths.

4. The method according to claim 1 wherein the material of low ductility one of aluminum, aluminum alloy, magnesium, and magnesium alloy.

5. The method according to claim 1 wherein the laser light heats the low ductile material within the bending region to a temperature between about 150° C. and about 500° C.

6. The method according to claim 1 comprising:
prior to hemming the first sheet performing the following:
providing a second sheet adjacent to the first sheet; and
securing the first sheet relative to the second sheet, said second sheet having a peripheral edge;
wherein hemming the first sheet comprises moving the roll forming assembly relative to the first sheet and the second sheet so as to fold the edge portion of the first sheet over the peripheral edge of the second sheet.

7. A method of hemming a low ductile material, comprising:
providing a first sheet made from the low ductile material;
providing an integrated hemming device comprising:
at least one laser head; and
a roll forming assembly comprising a roller,
wherein the at least one laser head is configured to direct laser light along two optical paths so as to form two irradiation spots that are at least partially non-overlapping one with the other;
hemming the first sheet, comprising moving the roll forming assembly relative to the first sheet along a hemming direction, the roll forming assembly being arranged relative to the first sheet to form a bending region in advance of the roll forming assembly, so as to fold an edge portion of the first sheet back upon itself during moving along the hemming direction;
using the at least one laser head, directing laser light along one of the two optical paths to irradiate with one of the two irradiation spots a first localized portion of the first sheet along the hemming direction at a first substantially constant predetermined distance in front of the roll forming assembly and within the bending region; and
using the at least one laser head, directing laser light along the other one of the two optical paths to irradiate with the other one of the two irradiation spots a second localized portion of the first sheet along the hemming direction at a second substantially constant predetermined distance in front of the roll forming assembly,
wherein the first localized portion and the second localized portion are at least partially non-overlapping one with the other.

8. The method according to claim 7 wherein the second localized portion is also within the bending region.

9. The method according to claim 7 wherein the at least one laser head comprises a single laser head and comprising using optical elements to direct a first portion of the laser light produced by the single laser head along the one of the two optical paths and to direct a second portion of the laser light produced by the single laser head along the other one of the two optical paths.

10. The method according to claim 7 wherein the at least one laser head comprises a first laser head and a second laser head and comprising using the first laser head to direct the laser light along the one of the two optical paths and using the second laser head to direct the laser light along the other one of the two optical paths.

11. The method according to claim 7 wherein the material of low ductility one of aluminum, aluminum alloy, magnesium, and magnesium alloy.

12. The method according to claim 7 wherein the laser light heats the low ductile material within the bending region to a temperature between about 150° C. and about 500° C.

13. The method according to claim 7 comprising:
prior to hemming the first sheet performing the following:
providing a second sheet adjacent to the first sheet; and
securing the first sheet relative to the second sheet, said second sheet having a peripheral edge;
wherein hemming the first sheet comprises moving the roll forming assembly relative to the first sheet and the second sheet so as to fold the edge portion of the first sheet over the peripheral edge of the second sheet.

14. A hemming apparatus for hemming a panel assembly including an outer panel and an inner panel, the apparatus comprising:
a roll forming assembly comprising a roller for hemming the panel assembly;
a retaining device for positioning the panel assembly relative to the roll forming assembly; and
a laser source;
wherein the laser source and the roll forming assembly are configured to be movable as a unit, and
wherein the laser source is configured to, during use, direct laser light along two optical paths so as to form two irradiation spots that are at least partially non-overlapping with one another other.

15. The hemming apparatus according to claim 14 wherein the laser source comprises a first laser head that is configured to direct laser light along a first one of the two optical paths and a second laser head that is configured to direct laser light along a second one of the two optical paths.

16. The hemming apparatus according to claim 14 wherein the laser source comprises a single laser head and optical elements to direct a first portion of the laser light produced by the single laser head along a first one of the two optical paths and to direct a second portion of the laser light produced by the single laser head along a second one of the two optical paths.

17. The hemming apparatus according claim 14 wherein the laser source is configured to, during use, form the two irradiation spots on respective at least partially non-overlapping portions of the panel assembly and along the hemming direction at respective substantially constant predetermined distances in front of the roller.

18. The hemming apparatus according claim 14 wherein the laser source is configured to, during use, form one of the two irradiation spots on a portion of the panel assembly and along the hemming direction at respective substantially constant predetermined distance in front of the roller and form the other of the two irradiation spots on a portion of the roller.
